(19) United States
(12) Patent Application Publication
(10) Pub. No.: US 2022/0073782 A1
(43) Pub. Date: Mar. 10, 2022

(54) SUPERHYDROPHILIC COATING COMPOSITION

(71) Applicant: NITTO DENKO CORPORATION, Osaka (JP)

(72) Inventors: Qianxi Lai, Carlsbad, CA (US); Jiadong Zhou, San Diego, CA (US); Yiling Zhang, Temecula, CA (US)

(21) Appl. No.: 17/309,825

(22) PCT Filed: Dec. 16, 2019
(86) PCT No.: PCT/US2019/066554

§ 371 Date: Jun. 21, 2021

Related U.S. Application Data
(60) Provisional application No. 62/785,174, filed on Dec. 26, 2018.
(60) Provisional application No. 62/785,175, filed on Dec. 26, 2018.

(51) Int. Cl. C09D 175/08; C08K 3/36; C08K 9/06; C08K 3/08; C09D 5/14; C08K 5/1535; C09D 7/43; C09D 7/62; C09D 7/63; C09D 175/06

(52) U.S. Cl. CPC C09D 175/08; C08K 3/36; C08K 9/06; C08K 3/08; C09D 5/14; C08K 5/1535; C08L 83/12; C09D 7/62; C09D 7/63; C09D 175/06; C08K 2201/011; C08K 2003/0806; C09D 7/43

(57) ABSTRACT

A composition, coating and/or method of facilitating the spreading of an aqueous solution upon a substrate includes coating the substrate with a composition comprising waterborne polymer, hydrophobic surface modified particles, and an amphiphilic compound, such that fluids that adhere to the coated substrate may be more easily removed from the substrate than from an uncoated substrate.

### CROSS REFERENCE TO RELATED APPLICATIONS

This application claims the benefit of United States Provisional Application Nos. 62/785,174, filed Dec. 26, 2018, and 62/785,175, filed Dec. 26, 2018, both of which are incorporated by reference in their entireties.

### FIELD

The present disclosure relates to superhydrophilic polymer composites and coatings based thereon for the protection of surfaces.

### BACKGROUND

The need for surfaces having self-cleaning, antimicrobial, and/or non-fouling characteristics has stimulated the development of advanced materials for use in biomedical, marine, food processing, and other applications where self-cleaning is needed.

In biomedical applications, a significant problem associated with implant devices is the formation of biofilm on the device surface and infection associated with the bacteria harbored in the biofilm. Antibiotics usually are not effective towards bacteria inside the biofilm. Thus, an effective anti-biofilm surface coating is needed.

In marine environments, surfaces become contaminated rapidly due to biofouling. Biofouling is the unwanted accumulation of microorganisms, plants, algae and animals on artificial structures immersed in sea, river or lake water. Current methods to combat biofouling include coatings containing environmentally unfriendly biocides or foul-release film which only remove the fouling when the boat or other marine vessel is moving.

In food industry settings, such as fresh food processing or beer/wine manufacturing, contamination on the equipment surface is a serious concern. The high nutrient content left on a food/beverage preparation surface provides bacteria regions to grow and thus poses a threat to food safety and hygiene control. Stainless-steel surfaces usually used in food processing equipment may be modified to be superhydrophobic, but this modification usually involves environmentally unfriendly fluorinated materials and complicated nanostructure.

Thus, a need for a better coating to prevent surface contamination is desired.

### SUMMARY

The present disclosure describes novel superhydrophilic polymer composites and coatings that are effective in reducing or eliminating the attachment of biological materials, organic matter, or organisms to surfaces, particularly surfaces in contact with water or in aqueous environments. The current disclosure includes polymer composites and coatings comprising a waterborne polymer, hydrophobic surface modified particles, and at least one amphiphilic compound, wherein the hydrophobic surface modified nanoparticles and the waterborne polymer are mutually miscible within each other. The polymer composites and coatings described herein may prevent liquid contamination of a surface. The polymer composites described herein can be useful for having anti-staining properties. The superhydrophilic polymer composites described herein can be useful for enhancing the cleaning of substrate surfaces exposed to liquid contaminants, for example in beverage/food processing industry.

In some embodiments, the waterborne polymer comprises an aqueous polyurethane polymer dispersion. In some embodiments, the hydrophobic surface modified particles may be organic particles or inorganic particles having a hydrophobic moiety covalently bound to, or coated on, the particle surface. In some embodiments, the hydrophobic surface modified particles can comprise a polydimethylsiloxane functionalized fumed silica. In some embodiments, the amphiphilic compound can be a nonionic surfactant which can comprise a hydrophobic core and appended hydrophilic moieties. In some embodiments, the amphiphilic compound can be a polyether-modified polydimethylsiloxane, such as DBE-311. In some embodiments, the amphiphilic compound can comprise a polysorbate, such as polysorbate 80.

In some embodiments, the composition can comprise an acrylic polymer. Some embodiments incorporate an antimicrobial agent in the composition. In some embodiments, the antimicrobial agent can be silver nanoparticles. In some examples, the composition can comprise a thickening agent. In some embodiments, the composition can comprise a crosslinker.

Some embodiments include a method for preparing a superhydrophilic polymer composition. In some examples, the method for preparing a superhydrophilic polymer composition can comprise providing a polyurethane aqueous dispersion, hydrophobic surface modified particles, and at least one amphiphilic compound. In some embodiments, the method for preparing a superhydrophilic polymer composition can comprise mixing the amphiphilic compound, hydrophobic surface modified particles and a polyurethane aqueous dispersion to create a polymer composite substantially uniformly dispersed blend. Some methods also comprise the addition of an acrylic polymer, an antimicrobial agent, a thickening agent, a crosslinker, or any combination thereof.

Some embodiments include a method for preventing liquid contamination of a surface. In some embodiments, the method comprises at least the step of forming a coating on the surface with a superhydrophilic polymer composite described herein. In some embodiments, a method comprises applying the superhydrophilic polymer composite on a substrate. Some embodiments include drying the superhydrophilic polymer composite on a substrate to form a uniform coating.

In some embodiments, the superhydrophilic polymer composites have a very low liquid sliding angle. In some embodiments, the composites have a very low water contact angle. In some embodiments, the polymer composites have anti-biofilm activity and antimicrobial activity.

In some embodiments, the superhydrophilic polymer composites can be prepared in a manner that is more practical, less costly, and more environmentally friendly than known antifouling compositions.

### BRIEF DESCRIPTION OF THE DRAWINGS

FIG. 1 is a schematic showing a coated substrate of the current disclosure.

### DETAILED DESCRIPTION

Described herein are polymer composites, and coatings composed thereof, having superhydrophilic properties. The term “superhydrophilic” surface refers to a surface on which water/liquid spreads to nearly zero contact angle (for example, <5°). In some embodiments, the superhydrophilic polymer composite comprises a waterborne polymer. In some examples, the superhydrophilic polymer composite comprises a plurality of hydrophobic surface modified particles. The term “waterborne” polymer refers to a polymer that can be mixed into a hydrophobic particle slurry to form a dispersion of hydrophobic particles and emulsified polymer. In some embodiments, the waterborne polymer of the polymer composite comprises a polyurethane polymer. In some examples, the polymer composite comprises at least one amphiphilic compound. The term “amphiphilic” refers to a molecule or compound that has both hydrophilic and hydrophobic properties. In some embodiments, the waterborne polymer and the hydrophobic surface modified particles are miscible within each other. In some embodiments, the waterborne polymer and the amphiphilic compound are miscible within each other. In some examples, the hydrophobic surface modified particles and the amphiphilic compound are miscible within each other. In some embodiments, the waterborne polymer, the hydrophobic surface modified particles, and the amphiphilic compound are miscible within each other. In some cases, the superhydrophilic polymer composite comprises an antimicrobial agent. In some embodiments, the superhydrophilic polymer composite comprises an acrylic polymer. Some composite coating embodiments include additional materials such as crosslinkers or thickeners. Also described herein are methods for preparing the polymer composites and coatings of the disclosure. Some embodiments include methods for using the embodiments of the disclosure as antimicrobial and/or antifouling coatings. Some composite coatings have a low liquid sliding angle. Some composite coatings have a low water contact angle. In some embodiments, the composite may have a high anti-biofilm activity versus P. aeruginosa. In some embodiments, the composite may have a high antimicrobial activity versus E. coli.

The polymer composites described herein can be useful for having and/or enhancing antimicrobial activity. In some embodiments, the superhydrophilic polymer composites may have or enhance antifouling activity. Some polymer composites described herein can be useful for having and/or enhancing anti-staining activity. In some examples, the polymer composites described herein can be useful for having and/or enhancing the cleaning of substrate surfaces exposed to a staining liquid contaminant.

In some embodiments, the superhydrophilic polymer composite comprises a polyurethane polymer. The polyurethane polymer component of the polymer composite may be provided in a variety of forms. In some embodiments, the polyurethane polymer can be a polyurethane resin. In some examples, the polyurethane comprises an aqueous polyurethane dispersion. In some embodiments, the polymer composite comprises an aliphatic polyether polyurethane dispersion. In some cases, the polyether polyurethane comprises polyether polyurethane dispersion Alberdingk Boley U205. In some examples, the polymer composite comprises an aliphatic polycarbonate polyurethane. In some embodiments, the polycarbonate polyurethane comprises aliphatic polycarbonate polyurethane dispersion Alberdingk Boley U6800. Other suitable polyurethane dispersions, including Alberdingk Boley U6150, Allnext TW 6490/35WA, TW 6491/33WA, TW 6492/36WA, VTW 1262/35WA, Brenntag Witcobond 781, Witcobond W-240, Witcobond 386-03, Witcobond A-100 and Witcobond W-320, and Mitsui Takelac WS-5000 are also contemplated and may be appropriate polyurethane dispersions. In some examples of the present disclosure, the superhydrophilic polymer composite can comprise a polyurethane matrix. It is believed that the polyurethane selected displays good film forming ability (film forming temperature <0° C.), good elasticity (max elongation before break >200%), and good hydrolysis resistance. It is believed that the polyurethane used in the embodiments of the current disclosure contribute these toughness and elasticity properties to the polymer composites.

Any suitable amount of polyurethane may be used in a superhydrophilic polymer composite, such as about 0.1-10 wt %, about 10-20 wt %, about 20-30 wt %, about 30-40 wt %, about 40-50 wt %, about 50-60 wt %, about 60-65 wt %, about 65-70 wt %, about 70-73 wt %, about 73-76 wt %, about 76-80 wt %, about 80-83 wt %, about 83-86 wt %, about 86-89 wt %, about 89-92 wt %, about 92-95 wt %, about 95-97 wt %, about 97-100 wt %, about 92-94 wt %, about 94-96 wt %, about 96-98 wt %, or about 98-100%, based upon the total weight of the superhydrophilic polymer composite.

In some embodiments, the composite can comprise one or more hydrophobic surface modified particles. In some examples, the composite can comprise a plurality of hydrophobic surface modified particles. In some embodiments, the hydrophobic surface modified particles, can comprise an inorganic particle or an organic particle. In some embodiments, the inorganic particle or an organic particle itself can be hydrophilic, e.g., fumed silica. In some embodiments, the inorganic particle can be a silica oxide, aluminum oxide or titanium oxide. In some embodiments, the silica oxide can be fumed silica and/or colloidal silica. In some examples, the hydrophobic surface functionalized particles can be polydimethylsiloxane functionalized fumed silica. In some embodiments, the hydrophobic surface functionalized particles can be octylsilane modified fumed silica. In some embodiments, the hydrophobic surface functionalized particles can be dimethyl modified or trimethyl functionalized fumed silica. In some embodiments, the hydrophobic surface modified particle can comprise a phyllosilicate. In some cases, the phyllosilicate can be montmorillonite. In some embodiments, wherein the hydrophobic particle is an organic particle, the organic particle can be a hydrophobic polymeric material. In some embodiments, the organic particle can be polystyrene. In some embodiments, the hydrophobic organic moiety can comprise a functional moiety comprising a polysiloxane, a halogen, or a C₁-C₃₀ alkyl group. In some embodiments, the polysiloxane can be linked to the organic particle by a silane linkage. In some embodiments, the halogen can be fluorine. In some embodiments, the C₁-C₃₀ alkyl functional moiety can be a saturated or unsaturated C₁₀-C₂₀ alkyl group, e.g., fatty acid substituents such as lauric acid, palmitic acid, stearic acid, and/or oleic acid.

One suitable polydimethylsiloxane functionalized fumed silica can be Aerosil R202 (PDMS functionalized fumed silica, Evonik, Industries AG, Essen, Germany). Other suitable polydimethylsiloxane functionalized fumed silica particles include Aerosil R208, R972, and RY50. In some embodiments, the hydrophobic surface modified particles can be an octylsilane modified fumed silica such as Aerosil R805. In some embodiments, the hydrophobic surface functionalized particles can be dimethyl modified or trimethyl modified fumed silica (R972 and R812).

In some embodiments the hydrophobic surface modified particles can comprise a particle with an average diameter of less than 10 μm. In some examples, the average diameter of the particles can be about 0.01-10 μm, about 0.03-5 μm, about 0.05-3 μm, about 0.01-1 μm, about 0.01-0.05 μm, about 0.05-0.1 μm, 0.1-0.2 μm, 0.2-0.3 μm, 0.3-0.4 μm, 0.4-0.5 μm, 0.5-0.6 μm, 0.6-0.7 μm, 0.7-0.8 μm, about 0.8-0.9 μm, about 0.9-1 μm, about 1-2 μm, about 2-3 μm, about 3-4 μm, about 4-5 μm, about 5-6 μm, about 6-7 μm, about 7-8 μm, about 8-9 μm, about 9-10 μm, or any diameter in a range bounded by any of these values. It is believed that the particles should be small to make a thinner coating.

In some embodiments, the weight percentage of the hydrophobic surface modified particles can be about 0.1-30%, about 0.1-0.5%, about 0.4-0.6%, about 0.6-0.8%, about 0.8-1%, about 1-1.2%, about 1.4-1.4%, about 1.4-1.6%, about 1.6-1.8%, about 1.8-2%, about 2-2.2%, about 2.2-2.4%, about 2.4-2.6%, about 2.6-2.8%, about 2.8-3%, about 0.5-1%, about 1-1.5%, about 1.5-2%, about 2-2.5%, about 2.5-3%, about 0.5-1%, about 1-2%, about 2-3%, about 3-4%, about 4-5%, about 5-6%, about 6-7%, about 7-8%, about 8-9%, about 9-10%, about 10-15%, about 15-20%, about 20-25%, about 25-30%, about 2-5%, about 5-8%, about 2%, about 3%, about 7%, of the total weight of the superhydrophilic polymer composition, or any weight percentage in a range bounded by any of these values.

In some embodiments, the superhydrophilic polymer composite comprises at least one amphiphilic compound. In some examples, the amphiphilic compound can be a nonionic amphiphilic compound. In some embodiments, the amphiphilic compound can be a nonionic surfactant compound. In some cases, the amphiphilic compound can comprise a hydrophilic moiety appended to a hydrophobic core or backbone. In some embodiments, the hydrophilic amphiphilic moiety can be a polyether. Some embodiments include an amphiphilic compound that is a functionalized polysiloxane. In some embodiments, the functionalized polysiloxane can be a functionalized polydialkylsiloxane. In some embodiments, the polysiloxane can be a polydimethylsiloxane. In some embodiments the polysiloxane can be a hydrophilic silicone. In some embodiments, the hydrophilic silicone can comprise a dimethylsiloxane molecular backbone in which some of the methyl groups are replaced by polyalkyloxyalkyl ether groups or polyalkyloxyalkyl hydroxyl groups linked through a propyl group to the silicon atom. In some embodiments, the functionalized polysiloxane can be a polyether modified polydimethylsiloxane. In some embodiments, the hydrophilic amphiphilic moiety can comprise a polyethylene oxide, a carbinol and/or a polyoxymethylene.

As used herein, the term ethylene oxide refers to a repeating unit, a functional group and/or a substituent including the structure:

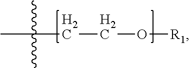

wherein R₁=H or —CH₃.

The term carbinol refers to an OH directly attached to a carbon atom.

The term polyoxymethylene refers to a repeating unit, a functional group and/or a substituent including the structure:

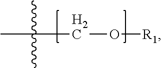

wherein R₁=H or —CH₃.

In some embodiments, the polysiloxane can be:

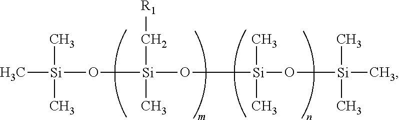

wherein m=1-40, n=1-40, and R₁ can be C₁-C₂₀ alkyl, e.g., C₁₋₅ alkyl, C₆₋₁₀ alkyl, C₁₁₋₁₅ alkyl, C₁₆₋₂₀ alkyl, C₁₋₁₀ alkyl, or C₁₁₋₂₀ alkyl.

In some embodiments, the siloxane can be

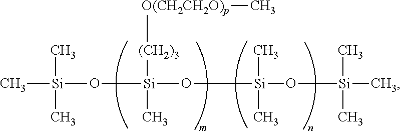

wherein m=1-40, n=1-40, and p=1-150.

In some embodiments, the functionalized siloxane can be of the formula:

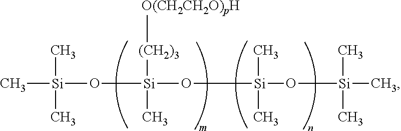

wherein m=1-40, n=1-40, and p=1-150.

The term “% substitution” is defined as (m/(m+n)×100%). In this definition, m refers to the amount the dimethylsiloxane units functionalized with hydrophilic side chain siloxane units (ethylene oxide or carbinol as shown above) an n refers to the amount of unfunctionalized dimethylsiloxane units. Therefore, m/(m+n) defines the percentage of hydrophilic pendant side chain siloxane in the entirety of the polysiloxane polymer. In some embodiments, the % substitution can be about 1% to about 90% substitution, about 1-2.5%, about 2.5-5%, about 5-10%, about 10-15%, about 15-20%, about 20-25%, about 25-30%, about 30-35%, about 35-40%, about 40-45%, about 45-50%, about 50-55%, about 55-60%, about 60-65%, about 65-70%, about 70-75%, about 75-80%, about 80-85%, about 85-90%%, about 1-10%, about 10-20%, about 20-30%, about 30-40%, about, 40-50%, about 50-60%, about 60-70%, about 70-80%, about 80-90%, about 2.5%, about 30%, about 50%, about 75%, about 90%, or any % substitution in a range bounded by any of these values. It is believed that a minimum amount of hydrophilic pendant side-chains are useful in improving the miscibility of the polysiloxane in the water-based polymer, e.g., polyurethane. It is further believed that the suitable % substitution by the pendant hydrophilic side chains (for example 5-30% substitution), makes the spacing of the hydrophilic pendant side chains loose enough so that they have freedom to swing and rotate, and/or can be swellable by the compatible liquid, and behave like liquid in that condition.

With respect to the siloxane or polysiloxane formulas above, in some embodiments, m can be 1-40, 1-5, 5-10, 10-15, 15-20, 20-25, 25-30, 30-35, 35-40, 1-10, 1-20, 5-15, 10-20, 15-25, 20-30, or 30-40. In some embodiments, n can be 1-40, 1-5, 5-10, 10-15, 15-20, 20-25, 25-30, 30-35, 35-40, 1-10, 1-20, 5-15, 10-20, 15-25, 20-30, or 30-40. In some embodiments, the length of the ethylene oxide side chain, p, can be 1-150, or 1-20. In some embodiments, p can be 1-2, 1-3, 2-3, 3-4, 4-5, 5-6, 6-7, 7-8, 8-9, 9-10, 10-11, 11-12, 12-13, 13-14, 14-15, 15-16, 16-17, 17-18, 18-19, 19-20, 20-30, 30-40, 40-50, 50-60, 60-70, 70-80, 80-90, 90-100, 100-110, 110-120, 120-130, 130-140, 140-150, 1-10, 1-5, or 1-3.

Any suitable dimethylsiloxane-ethylene oxide block/graft copolymer can be employed in the present disclosure. One suitable dimethylsiloxane-ethylene oxide block/graft copolymer can be DBE-311 (CAS 68938-54-5) (Gelest, Inc. Morrisville, Pa., USA) which has about 30% of the methyl groups substituted with ethylene oxide substituent groups. Other suitable hydrophilic polysiloxanes comprise dimethylsiloxane-(60-70% ethylene oxide) block copolymer DBE-712 (Gelest), dimethylsiloxane-(85-90% ethylene oxide) block copolymer DBE-921 (Gelest), (20% carbinol functional) methylsiloxane-dimethylsiloxane copolymer CMS-221 (Gelest), or any combination of any of the hydrophilic polysiloxanes above.

In some embodiments, both ethylene oxide or carbinol functionalized polysiloxanes can be included in the polymer composition. In some embodiments, the functionalized polysiloxane is substantially miscible in the polyurethane dispersion. The uniformly mixed blend can be indicated by the smooth liquid film left on the container wall when the container is tilted or the smooth liquid on the substrate when casted by a blade. In some embodiments, the hydrophilic polymer and the functionalized polysiloxane can be miscible within each other. In some embodiments, the blend of the hydrophilic polymer and the functionalized polysiloxane can be a homogeneous solution at any ratio to each other.

In some embodiments, the amphiphilic compound can comprise a hydrophobic moiety. In some embodiments, amphiphilic hydrophobic moiety can be independently a polysiloxane, a halogen, and/or a C₁-C₃₀ alkyl chain, e.g., C₁₂-C₁₈ fatty acid chain. In some embodiments, the halogen hydrophobic moiety can be fluorine. It is believed that the purpose of the amphiphilic compound may be to help the hydrophobic particles uniformly disperse in the aqueous polymer solution, like an emulsifier or disperser.

The choice of the amphiphilic compound depends on the similarity between the composition of the waterborne polymer and the composition of the amphiphilic compound. In some embodiments, the waterborne polymer can be a polyether polyurethane and the amphiphilic compound can be a polyether-modified polydimethylsiloxane, e.g., DBE-311. In some embodiments, the waterborne polymer can be an aliphatic polycarbonate polyurethane and the amphiphilic compound can be a polyoxyethylene sorbitan mono(C₁₁-C₂₀ saturated or unsaturated alkyl chain, e.g., fatty acid), e.g., polysorbate 80 (monooleate, Millipore Sigma, Burlington, Mass., USA). Other suitable polyoxyethylene sorbitan mono(C₁₁-C₂₀ saturated or unsaturated alkyl chain) amphiphilic compounds comprise polysorbate 20 (monolaurate), polysorbate 40 (monopalmitate), and polysorbate 60 (monostearate). In some embodiments, more than one amphiphilic compound can be used in the mixture.

The superhydrophilic polymer composites described herein may contain any suitable amount of amphiphilic compound. In some embodiments, the weight percentage of the amphiphilic compound (e.g., DBE-311 or polysorbate 80) in the total amount of the polymer composite can be about 1-30 wt %, about 0.2-0.4%, about 0.4-0.6%, about 0.6-0.8%, about 0.8-1%, about 1-1.2%, about 1.4-1.4%, about 1.4-1.6%, about 1.6-1.8%, about 1.8-2%, about 2-2.2%, about 2.2-2.4%, about 2.4-2.6%, about 2.6-2.8%, about 2.8-3%, about 0-0.5%, about 0.5-1%, about 1-1.5%, about 1.5-2%, about 2-2.5%, about 2.5-3%, about 1-2 wt %, about 2-3 wt %, about 3-4 wt %, about 4-5 wt %, about 5-6 wt %, about 6-7 wt %, about 7-8 wt %, about 8-9 wt %, about 9-10 wt %, about 10-11 wt %, about 11-12 wt %, about 12-13 wt %, about 13-14 wt %, about 14-15 wt %, about 15-16 wt %, about 16-17 wt %, about 17-18 wt %, about 18-19 wt %, about 19-20 wt %, about 20-21 wt %, about 21-22 wt %, about 22-23 wt %, about 23-24 wt %, about 24-25 wt %, about 25-26 wt %, about 26-27 wt %, about 27-28 wt %, about 28-29 wt %, about 29-30 wt %, about 1-5 wt %, about 5-10 wt %, about 10-15 wt %, about 15-20 wt %, about 20-25 wt %, about 25-30 wt %, about 1-10 wt %, 10-20 wt %, 20-30 wt %, 2-20 wt %, about 5-30 wt %, about 5-10 wt %, 5 wt %, 10 wt %, or any weight percent bounded by any of the above ranges.

In some embodiments, the superhydrophilic polymer composite comprises an acrylic polymer. It is believed that the acrylic polymer component reduces the permeability or penetration of water through the composite. Suitable acrylic polymers include AP609LN and/or AP4690N (Showa Denko Group, Tokyo, Japan). In some embodiments, the composite can comprise 10-90 wt % acrylic polymer to 90-10 wt % polyurethane dispersion. The acrylic polymer may comprise about 10-15 wt %, about 15-20 wt %, about 20-25 wt %, about 25-30 wt %, about 30-35 wt %, about 35-40 wt %, about 40-45 wt %, about 45-50 wt %, about 50-55 wt %, about 55-60 wt %, about 60-65 wt %, about 65-70 wt %, about 70-75 wt %, about 75-80 wt %, about 80-85 wt %, about 85-90 wt %, about 18-22 wt %, about 47-53 wt %, about 76-84 wt %, about 10-30 wt %, about 30-50 wt %, about 50-70 wt %, about 70-90 wt %, about 20 wt %, about 50 wt %, about 80 wt %, or any weight percentage of the total weight of the superhydrophilic polymer composite bounded by any of these values.

In some embodiments, the superhydrophobic polymer composite can comprise an antimicrobial agent. In some embodiments, the anti-microbial agent can be silver nanoparticles. Suitable silver nanoparticles include non-coated silver nanoparticles, PVP coated silver nanoparticles, and oleic acid coated silver nanoparticles (all available from SkySpring Nanomaterials, Inc., Houston, Tex.). Any suitable amount of silver nanoparticles may be used in the polymer composites of the present disclosure. In some embodiments, the weight percentage of the silver nanoparticles in the superhydrophilic polymer composite may comprise about 0.01-1 wt %, about 0.01-0.05 wt %, about 0.05-0.1 wt %, about 0.1-0.2 wt %, about 0.2-0.3 wt %, about 0.3-0.4 wt %, about 0.4-0.5 wt %, about 0.5-0.6 wt %, about 0.6-0.7 wt %, about 0.7-0.8 wt %, about 0.8-0.9 wt %, about 0.9-1 wt %, about 0.1 wt %, about 0.2 wt %, about 0.5 wt %, about 0.6 wt %, or any weight percentage in a range bounded by any of these values.

In some embodiments, the composite can comprise a thickening agent. In some embodiments, the thickening agent can be a nonionic polymer. In some embodiments, the nonionic polymer can be hydrophobically modified. A suitable thickening agent can be OPTIFLO T1000 (BYK-Chemie GmbH, Wesel, Germany). In some embodiments, the thickening agent is present at about 0.1-2 wt % based upon the total weight of the composite.

In some embodiments, the composite can comprise a crosslinker. In some embodiments, the crosslinker can be compatible with polyurethane. In some embodiments, the crosslinker crosslinks the polyurethane polymer/monomer. In some examples, the crosslinker can be hydrophilic. In some embodiments, the crosslinker can be aliphatic. In some embodiments, the crosslinker can be a polyisocyanate. In some cases, the crosslinker can be a hexamethylene diisocyanate analog. A suitable crosslinker can be Bayhydur XP 2547 (Covestro AG, Leverkusen, Germany). In some embodiments, the cross-linker is about 0.1-5% of the total weight of the composite.

In some embodiments, the superhydrophilic polymer compositions described herein may be used to create a coating for a surface. Some examples include surface coatings that have a water contact angle of <5 degrees (superhydrophilic), <4 degrees, <3 degrees, or <1 degree, e.g., for 200 μL of DI water. In some embodiments, a superhydrophilic coating described herein can be used to make a liquid contaminant in, for example, beverage/food processing equipment, easy to spread and have a thinner fouling layer, thus enhancing the cleaning of equipment surfaces exposed to liquid contaminant.

It is believed that the hydrophobic surface modified particles are uniformly dispersed in the aqueous polymer solution because of the compatible amphiphilic compound surrounding them with hydrophobic ends pointing inside and hydrophilic cores pointing to the aqueous solution. As the polymer composition is applied on a substrate and drying, the hydrophobic surface modified particles tend to accumulate on the coating surface meanwhile bringing the amphiphilic compound around them together to the surface, thus causing a high density of hydrophilic groups to be embedded just below the surface. Once the coating surface is exposed to aqueous solution, the large amount of hydrophilic chains may extend to the aqueous solution at the interface, making the surface superhydrophilic.

It is believed that the choice of the amphiphilic compound depends on the similarity between the constituents of the aqueous polymer and the constituents of the amphiphilic compound. The appropriate amphiphilic compound aids the dispersion of the hydrophobic surface modified particles in certain types of aqueous polymer solutions. In some embodiments, the aqueous polymer is an aliphatic polyether polyurethane and the amphiphilic compound is a polyether-modified polydimethylsiloxane because they both contain polyether portions in their structure, making them more miscible. In some embodiments, the aqueous polymer is an aliphatic polycarbonate polyurethane and the amphiphilic compound is a polyoxyethylene sorbitan mono(C₁₁-C₂₀ saturated or unsaturated alkyl group [fatty acid]) because they both contain aliphatic portions in their structure, making them more miscible. In some embodiments, more than one amphiphilic compound can be used in the mixture. For example, a polyether-modified polydimethylsiloxane (e.g., DBE-311) and a polyoxyethylene sorbitan mono(C₁₁-C₂₀ saturated or unsaturated alkyl group, e.g., polysorbate 80) can be used together to make a substantially uniform dispersion with an aliphatic polyether polyurethane and polydimethylsiloxane grafted fumed silica nanoparticles.

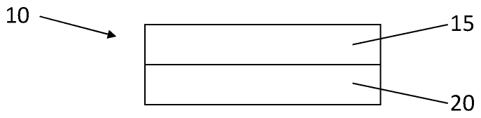

As shown in FIG. 1, in some embodiments, a coating 10 can comprise the aforedescribed polymer composite. In some embodiment, the polymer composite 15 can be disposed upon a substrate 20 surface and dried. In some embodiments, the coating can be dried by spray coating, casting, dip coating, brush coating or roller coating.

In some examples, the composite may be cast on a substrate with a wet thickness of 1-2000 μm. In some embodiments, the wet thickness can be 300-1250 μm. In some cases, the resultant dried polymer composite can be 1-1000 μm thick. In some embodiments, the dried coating can be 150-600 μm thick. Some examples include a wet thickness of 1-100 μm, 100-200 μm, 200-300 μm, 300-400 μm, 400-500 μm, 500-600 μm, 600-700 μm, 700-800 μm, 800-900 μm, 900-1000 μm, 1000-1250 μm, 1250-1500 μm, 1500-1750 μm, 1750-2000 μm, 625 μm, or any thickness in a range bounded by any of these values. In some embodiments, the dried composite can have a thickness of 1-25 μm, 25-50 μm, 50-75 μm, 75-100 μm, 100-125 μm, 125-150 μm, 150-200 μm, 200-250 μm, 250-300 μm, 300-400 μm, 400-500 μm, 500-600 μm, or any thickness in a range bounded by any of these values. The coating can be cast, brush coated, or roller coated.

In some embodiments, the dried coating can be peelable with controllable peel strength with range of 1-20N/20 mm.

Some embodiments include a method of making a polymer composite. In some cases, the method can comprise providing a hydrophilic pendant side chain functionalized polysiloxane and a waterborne polyurethane and physically mixing the two together. In some embodiments, the method can comprise providing an amphiphilic compound. The physical mixing of the amphiphilic compound and the hydrophobic surface modified particles with the preformed polyurethane resin or water based polyurethane dispersion provides a simpler and more practical way to prepare the composite mixture, as compared to incorporating these elements into the polyurethane during crosslinking by using reactive terminal groups. Also, the process in the present disclosure involves neither involve organic solvents nor catalysts that are usually used in 2-component polyurethane compositions, making the process described herein more environmentally friendly.

Some embodiments include a method for facilitating the removal of water and/or aqueous solutions from a substrate. In some embodiments, the aqueous solution can comprise a protein. In some embodiments, the aqueous solution can comprise a carbohydrate. In some embodiments, the method comprises coating the substrate with the superhydrophilic polymer compositions described herein, such that the aqueous solution or the materials contained within the solution may be more easily removed from the coated substrate than from an uncoated substrate. In some embodiments, the method facilitates or reduces the cleaning of a fluid containing a protein and/or a carbohydrate. In some embodiments, fluid containing a protein and/or a carbohydrate can be beer or wort. In some embodiments, the fluid containing a protein, and/or a carbohydrate can be milk or other dairy products. In some embodiments, the method reduces fouling of a surface comprising at least the step of placing in contact with the surface a superhydrophilic polymer composition described herein. In some embodiments, the composition to be placed in contact comprises a polymer. In some embodiments, the composition to be placed in contact comprises an inorganic hydrophobic particle. In some embodiments, the composition to be placed in contact comprises an amphiphilic compound described herein. In some embodiments, the composition to be placed in contact comprises a polysiloxane. In some embodiments, the composition to be placed in contact comprises a hydrophilic polymer, a polysiloxane, an amphiphilic compound, a hydrophobic particle, an antimicrobial agent, or any combination thereof, and to allow the coating to form on the surface. In some embodiments, a method of processing an aqueous solution comprising a fluid, food and/or composition containing proteins or carbohydrates incorporates at least the steps of: a) preparing a surface of any equipment in accordance with a method described herein; and, b) processing the fluid, food or composition in the aqueous solution containing proteins and/or carbohydrates with the coated equipment.

In some embodiments, the method further comprises exposing the superhydrophilic polymer composite and/or coating to a working fluid. In some embodiments, the working fluid can contain microbes, whereby the superhydrophilic polymer composite and/or coating kills microbes as a result of exposure to the working fluid. In some embodiments, the microbes controlled can comprise E. coli. In some embodiments, the membrane can have an antibacterial effectiveness of 2.0 or more. The antibacterial effectiveness can be determined by standard JIS Z 2801 (2012). In some embodiments, the working fluid can comprise beer and/or any food substance. In some embodiments, the working fluid can comprise water. In some embodiments, the working fluid can comprise a mixture of air and water vapor. In some embodiments, the mixture of air and water vapor can have a relative humidity ranging from about 100% to about 0%. In some embodiments, the relative humidity can range from 0-10%, 10-20%, 20-30%, 30-40%, 40-50%, 50-60%, 60-70%, 70-80%, 80-90%, 90-100%, or any humidity value in a range bounded by any of these values.

In accordance with the present disclosure, a “surface” is any part of a piece of equipment which may come into contact with water soluble materials. In some embodiments, the material can be one or more proteins. In some embodiments, the material can be one or more carbohydrates. In some embodiments, the material can be a substantially aqueous solution. In some embodiments, the material can be beer or wort. The surface may comprise the entire surface which may come in contact with one or more of the aforedescribed materials, or a part of such entire surface. In the context of the dairy industry, equipment may include, for example, the plant or any individual part thereof, such as vats, vessels, pumps, tans, mixers, coolers, pipelines and the like, or equipment and vessels involved in milking, packaging or shipping dairy products such as milk. Surfaces and equipment of relevance to other industries will readily be appreciated by persons skilled in the art. By way of general example, the equipment surfaces may include bioreactors, fermentation vats and the like.

Those of ordinary skill in the art recognize ways to determine the dewetting property of the surface. One example can be determining the slide angle of the treated substrate by the decrease of the angle at which the sample begins to slide off the treated substrate. In one example, a 20 μl droplet of deionized water was placed upon a treated steel substrate and the substrate surface was tilted from the horizontal until the droplet was visually perceived to slide and leave no/minimal residue behind it. In some embodiments, the slide angle of the described coating can be less than 25°, less than 20°, less than 15°, less than 12.5°, or less than 10° from the horizontal.

Another example includes determining the contact angle of the fluid upon the treated substrate by measuring the contact angle of the sample and the treated substrate. In one example, a 20 μl droplet of deionized water and/or beer or wort can be placed upon a treated steel substrate and the surface area and/or the contact angle of the resultant droplet can be ascertained, as more fully described in Example 17. In some embodiments, the contact angle of the described coating can be less than 25°, less than 20°, less than 15°, less than 12.5°, less than 10°, or less than 5°. In some embodiments, the change in surface area can be greater than 25%, greater than 50%, greater than 75%, greater than 100%, greater than 250%, greater than 500%, or greater than 1000% of the amount on an untreated surface.

Those of ordinary skill in the art recognize ways to determine the anti-biofilm property of the surface. In some embodiments, the ability of the coating to inhibit biofilm formation on its surface can be tested in a Center for Disease Control (CDC) biofilm reactor in comparison with other common perceived hydrophobic material like PTFE and antifouling materials like Ag and Cu sheet, as more fully described in Example 18. In some embodiments, the described coating can suppress the growth of P. Aeruginosa biofilm by 88% compared to the reference untreated stainless-steel plate.

Exemplary but non-limiting embodiments are as follows:

Embodiment 1. A superhydrophilic polymer composition comprising:

i. a waterborne polymer;

ii. a plurality of hydrophobic surface modified particles; and

iii. at least one amphiphilic compound, wherein the hydrophobic surface modified particles and the waterborne polymer are miscible within each other.

Embodiment 2. The polymer composition of embodiment 1, further comprising an acrylic polymer emulsion.

Embodiment 3. The polymer composition of embodiment 1, further comprising an antimicrobial agent.

Embodiment 4. The polymer composition of embodiment 3, wherein the antimicrobial agent comprises silver nanoparticles.

Embodiment 5. The polymer composition of embodiment 1, further comprising a thickening agent.

Embodiment 6. The polymer composition of embodiment 1, further comprising a crosslinker.

Embodiment 7. The polymer composition of embodiment 1, wherein the waterborne polymer comprises an aqueous polyurethane dispersion.

Embodiment 8. The polymer composition of embodiment 1, wherein the hydrophobic surface modified particles have a surface, and a hydrophobic organic moiety covalently bonded to the surface.

Embodiment 9. The polymer composition of embodiment 8, wherein the hydrophobic organic moiety is a polysiloxane, halogen, or a C₁-C₃₀ alkyl group.

Embodiment 10. The polymer composition of embodiment 8, wherein the hydrophobic surface modified particles comprises a particle with an average diameter of less than 10 um.

Embodiment 11. The polymer composition of embodiment 8, wherein the hydrophobic surface modified particles is an inorganic or an organic particle.

Embodiment 12. The polymer composition of embodiment 11, wherein the inorganic particle is a silica oxide, aluminum oxide or titanium oxide.

Embodiment 13. The polymer composition of embodiment 12, wherein the silica oxide is fumed silica, or colloidal silica.

Embodiment 14. The polymer composition of embodiment 11, wherein the inorganic particle is a phyllosilicate.

Embodiment 15. The polymer composition of embodiment 8, wherein the hydrophobic surface modified particles comprise polydimethylsiloxane functionalized fumed silica

Embodiment 16. The polymer composition of embodiment 11 wherein the organic particles can be polystyrene.

Embodiment 17. The polymer composition of embodiment 8, wherein the weight percentage of the hydrophobic surface modified particles can be 0.1-30%

Embodiment 18. The polymer composition of embodiment 1, wherein the amphiphilic compound is a nonionic surfactant comprising a hydrophilic amphiphilic compound moiety and a hydrophobic amphiphilic compound moiety.

Embodiment 19. The polymer composition of embodiment 18, wherein the hydrophilic amphiphilic compound moiety comprises a polyether.

Embodiment 20. The polymer composition of embodiment 18, wherein the hydrophobic moiety of the amphiphilic compound is polysiloxane, or a C₁-C₃₀ alkyl group.

Embodiment 21. The polymer composition of embodiment 1, wherein the amphiphilic compound is a polyether-modified polydimethylsiloxane.

Embodiment 22. The polymer composition of embodiment 1, wherein the amphiphilic compound comprises a polysorbate.

Embodiment 23. The polymer composition of embodiment 1, wherein the weight percentage of the amphiphilic compound can be 0.1-30%

Embodiment 24. The polymer composition of embodiment 1, wherein the surface of the polymer composition coating is superhydrophilic.

Embodiment 25. A method for preventing liquid contaminants on a surface comprising at least the step of forming a coating on the surface a composition of any one of embodiments 1-23.

Embodiment 26. A method of preparing a superhydrophilic polymer composition, comprising:

a. Providing a polyurethane aqueous dispersion, hydrophobic surface modified particles and at least one amphiphilic compound, and

b. Mixing the amphiphilic compound, hydrophobic surface modified particles and a polyurethane aqueous dispersion to create a polymer composite substantially uniformly dispersed blend.

c. Applying the polymer composite on a substrate; and

d. Drying the polymer composite on a substrate to form a uniform coating.

Embodiment 27. A method of processing an aqueous composition, the method comprising at least the steps of:

a) preparing a surface of any equipment in accordance with a method of any one of embodiments 1-23; and

b) processing with the equipment the composition containing the aqueous composition.

### EXAMPLES

It has been discovered that embodiments of the superhydrophilic compositions described herein have improved performance as compared to other compositions and/or surface coated herewith. These benefits are further demonstrated by the following examples, which are intended to be illustrative of the disclosure only but are not intended to limit the scope or underlying principles in any way.

### I. Synthesis

### Example-1: Preparation of the Solution

30 g of water based aliphatic polyether polyurethane dispersion (PUD) U205 (Alberdingk Boley, Greensboro, N.C., USA) was mixed with 0.9 g (^{˜}0.9 mM) dimethylsiloxane-(30-35% ethylene oxide) block copolymer DBE-311 (Gelest, Inc., Morrisville, Pa., USA) and 0.45 g PDMS grafted fumed silica Aerosil R202 (Evonik, Inc., Parsippany, N.J.). The solution was stirred using magnetic stir bar at room temperature. A uniform solution was obtained after 12 hours of stirring. The viscosity of the resultant example was about 100-500 mPa. If the viscosity was below 100 mPa, a thickener like Aerosil R50 can be added at 1-10 wt %.

### Example-2: Preparation of the Solution Using Aliphatic Polycarbonate PU Dispersion

30 g of water based polyurethane dispersion (PUD) U6800 (Alberdingk Boley, Greensboro, N.C., USA) was mixed with 0.5 g (^{˜}0.9 mM) polysorbate 80 (Sigma Aldrich, USA) and 0.3 g PDMS grafted fumed silica Aerosil R202 (Evonik, Inc., Parsippany, N.J.). The solution was stirred using magnetic stir bar at room temperature. A uniform solution was obtained after 12 hours of stirring. The viscosity of the resultant example was about 100-500 mPa.

### Example-3A-C: Solution Using Aliphatic Polycarbonate PU Dispersion and Acrylate Emulsion

2 g (3A) [alternatively: 5 g (3B); 8 g (3C)] of water polyurethane dispersion (PUD) U6800 (Alberdingk Boley, Greensboro, N.C., USA) was mixed with 8 g (3A) [alternatively: 5 g (3B); 2 g (3C)] of AP609LN (Showa Denko Group, Tokyo, Japan) and optionally 0.2 g of polysorbate 80 (MilliporeSigma, Burlington, Mass., USA). The solution was mixed using Planetary Centrifugal Mixer THINKY ARE-310 (THINKY Corporation, Tokyo, Japan) for 3 min, then was defoamed using the same for 2 min. A uniform solution was obtained.

### Example-4A-C: Preparation of the Solution Using Aliphatic Polycarbonate PU Dispersion and Acrylate Emulsion

2 g (4A) [alternatively: 5 g (4B); 8 g (4C)] of water based polyurethane dispersion (PUD) U6800 (Alberdingk Boley, Greensboro, N.C., USA) was mixed with 8 g (4A) [alternatively: 5 g (4B); 2 g (4C)] of AP609LN (Showa Denko Group, Tokyo, Japan), 0.2 g of dimethyl modified fumed silica R972 (Evonik, Inc., Parsippany, N.J.), and 0.2 g of polysorbate 80 (MilliporeSigma, Burlington, Mass., USA). The suspension was stirred using magnetic stir bar at room temperature for at least 15 hours, then was defoamed using Planetary Centrifugal Mixer THINKY ARE-310 (THINKY Corporation, Tokyo, Japan) for 2 min. A uniform suspension was obtained.

### Example-5: Preparation of the Solution Using Aliphatic Polycarbonate PU Dispersion and Acrylate Emulsion

5 g of water based polyurethane dispersion (PUD) U6800 (Alberdingk Boley, Greensboro, N.C., USA) was mixed with 5 g of AP4690N (Showa Denko Group, Tokyo, Japan). The solution was mixed using Planetary Centrifugal Mixer THINKY ARE-310 (THINKY Corporation, Tokyo, Japan) for 3 min, then was defoamed using the same for 2 min. A uniform solution was obtained.

### Example-6: Preparation of the Solution Using Aliphatic Polycarbonate PU Dispersion and Acrylate Emulsion

5 g of water based polyurethane dispersion (PUD) U6800 (Alberdingk Boley, Greensboro, N.C., USA) was mixed with 5 g of AP4690N (Showa Denko Group, Tokyo, Japan), 0.2 g of dimethyl modified fumed silica R972 (Evonik, Inc., Parsippany, N.J.), and 0.2 g of polysorbate 80 (MilliporeSigma, Burlington, Mass., USA). The suspension was stirred using magnetic stir bar at room temperature for at least 15 hours, then was defoamed using Planetary Centrifugal Mixer THINKY ARE-310 (THINKY Corporation, Tokyo, Japan) for 2 min. A uniform suspension was obtained.

### Example-7A-B: Preparation of the Solution Using Aliphatic Polyether PU Dispersion and Acrylate Emulsion

5 g of water based aliphatic polyether polyurethane dispersion (PUD) U205 (Alberdingk Boley, Greensboro, N.C., USA) was mixed with 5 g of AP609LN (Showa Denko Group, Tokyo, Japan) and optionally (with=7A, without=7B) 0.26 g of dimethylsiloxane-(30-35% ethylene oxide) block copolymer DBE-311 (Gelest, Inc., Morrisville, Pa., USA). The solution was mixed using Planetary Centrifugal Mixer THINKY ARE-310 (THINKY Corporation, Tokyo, Japan) for 3 min, then was defoamed using the same for 2 min. A uniform solution was obtained.

### Example-8: Preparation of the Solution Using Polyester PU Dispersion and Acrylate Emulsion

2 g of water based polyester polyurethane dispersion (PUD) Takelac WS-5000 (Mitsui Chemicals, Tokyo, Japan) was mixed with 8 g of AP609LN (Showa Denko Group, Tokyo, Japan). The solution was mixed using Planetary Centrifugal Mixer THINKY ARE-310 (THINKY Corporation, Japan) for 3 min, then was defoamed using the same for 2 min. A uniform solution was obtained.

### Example-9: Preparation of the Solution Using Polyester PU Dispersion and Acrylate Emulsion

2 g of water based polyester polyurethane dispersion (PUD) Takelac WS-5000 (Mitsui Chemicals, Tokyo, Japan) was mixed with 8 g of AP609LN (Showa Denko Group, Tokyo, Japan), 0.2 g of dimethyl modified fumed silica R972 (Evonik, Inc., Parsippany, N.J.), and 0.2 g of polysorbate 80 (MilliporeSigma, Burlington, Mass., USA). The suspension was stirred using magnetic stir bar at room temperature for several hours, then was defoamed using Planetary Centrifugal Mixer THINKY ARE-310 (THINKY Corporation, Tokyo, Japan) for 2 min. A uniform suspension was obtained.

### Example-10A1-3; 10B1-3; 10C1-3: Preparation of the Solution Using Aliphatic Polyether PU Dispersion and Silver Nanoparticles

60 g of water based polyurethane dispersion (PUD) U6800 (Alberdingk Boley, Greensboro, N.C., USA) was mixed with 1 g (^{˜}0.9 mM) of polysorbate 80 (MilliporeSigma, Burlington, Mass., USA), 1 g (10A) [alternatively: 0.4 g (10B); 1.6 g (10C)] of Aerosil R972 (Evonik, Inc., Parsippany, N.J., USA), and 120 mg of silver nanoparticles [alternatively: non-coated (10A1, 10B1, 10C1); PVP-coated (10A2, 10B2, 10C2); oleic acid coated (10A3, 10B3, 10C3), SkySpring Nanomaterials, Inc, Houston, Tex., USA). The solution was mixed on rolling mixer (US Stoneware, East Palestine, Ohio, USA) at room temperature. A uniform solution was obtained after 24 hours of stirring.

### Example-11A-C: Preparation of the Solution Using Aliphatic Polyether PU Dispersion and Silver Nanoparticles

60 g of water based polyurethane dispersion (PUD) U6800 (Alberdingk Boley, Greensboro, N.C., USA) was mixed with 1 g (^{˜}0.9 mM) of polysorbate 80 (MilliporeSigma, Burlington, Mass., USA) and 120 mg of silver nanoparticles (11A: non-coated; 11B: PVP-coated; 11C: oleic acid coated; SkySpring Nanomaterials, Inc, Houston, Tex., USA). The solution was mixed on rolling mixer (US Stoneware, East Palestine, Ohio, USA) at room temperature. A uniform solution was obtained after 24 hours of stirring.

In the above Examples-10 & 11, other silver nanoparticles have also been used: PVP coated silver nanoparticles (99.95%, 20-30 nm, SkySpring Nanomaterials, Inc, Houston, Tex., USA); and oleic acid coated silver nanoparticles (99.95%, 320-50 nm, SkySpring Nanomaterials, Inc, Houston, Tex., USA).

### Example-12: Preparation of the Solution Using Aliphatic Polyether PU Dispersion, Acrylate Emulsion, and Silver Nanoparticles

30 g of water based polyurethane dispersion (PUD) U6800 (Alberdingk Boley, Greensboro, N.C., USA) will be mixed with 30 g of AP609LN (Showa Denko Group, Tokyo, Japan), 1 g of polysorbate 80 (MilliporeSigma, Burlington, Mass., USA), and 120 mg of silver nanoparticles (SkySpring Nanomaterials, Inc, Houston, Tex., USA). The solution will be mixed on a rolling mixer (US Stoneware, East Palestine, Ohio, USA) at room temperature. A uniform solution will be obtained after 24 hours of mixing.

### Example-13: Preparation of the Solution Using Aliphatic Polyether PU Dispersion, Acrylate Emulsion, and Silver Nanoparticles

30 g of water based polyurethane dispersion (PUD) U205 (Alberdingk Boley, Greensboro, N.C., USA) will be mixed with 30 g of AP609LN (Showa Denko Group, Tokyo, Japan), 1 g of dimethylsiloxane-(30-35% ethylene oxide) block copolymer DBE-311 (Gelest, Inc., Morrisville, Pa., USA), and 120 mg of silver nanoparticles (SkySpring Nanomaterials, Inc, Houston, Tex., USA). The solution will be mixed on a rolling mixer (US Stoneware, East Palestine, Ohio, USA) at room temperature. A uniform solution will be obtained after 24 hours of mixing.

### Example-14: Preparation of the Solution Using Aliphatic Polyether PU Dispersion, Thickener, Crosslinker, and Silver Nanoparticles

60 g of water based polyurethane dispersion (PUD) U6800 (Alberdingk Boley, Greensboro, N.C., USA) was mixed with 1 g (^{˜}0.9 mM) of polysorbate 80 (MilliporeSigma, Burlington, Mass., USA), 0.6 g of T-1000, and 30 mg of silver nanoparticles (SkySpring Nanomaterials, Inc, Houston, Tex., USA). The mixture was stirred using magnetic stir bar at room temperature for 1-3 hours. 2 g of XP2547 was added to the mixture. The mixture was further stirred for 15 min, then defoamed using Planetary Centrifugal Mixer THINKY ARE-310 (THINKY Corporation, Tokyo, Japan) for 2 min.

### Example 15: Preparation of the Solution Using Aliphatic Polyether PU Dispersion, Surfactant, and Silver Nanoparticles

60 g of water based polyurethane dispersion (PUD) U6800 (Alberdingk Boley, Greensboro, N.C., USA) was mixed with 0.2 g of polysorbate 80 (MilliporeSigma, Burlington, Mass., USA) and 36 mg of silver nanoparticles (SkySpring Nanomaterials, Inc, Houston, Tex., USA). The solution was mixed on rolling mixer (US Stoneware, East Palestine, Ohio, USA) at room temperature. A uniform solution was obtained after 2 hours of stirring.

TABLE 1

| | PU | | Acrylic | | Fumed | | Amphiphilic | | Ag | Mixing | | |
|---|---|---|---|---|---|---|---|---|---|---|---|---|
| Ex-# | Dispersion | | polymer | | silica | | cmpd | | nanoparticles | method | Thickener | Crosslinker |
| Ex-1 | 30 | g^{a} | — | | 0.45 | g^{f} | 0.9 | g^{m} | — | A | | |
| Ex-2 | 30 | g^{b} | — | | 0.3 | g^{f} | 0.5 | g^{o} | — | A | | |
| Ex-3A | 2 | g^{b} | 8 | g^{d} | — | | 0.2 | g^{o} | — | B | | |
| Ex-3B | 5 | g^{b} | 5 | g^{d} | — | | 0.2 | g^{o} | — | B | | |
| Ex-3C | 8 | g^{b} | 2 | g^{d} | — | | 0.2 | g^{o} | — | B | | |
| Ex-4A | 2 | g^{b} | 8 | g^{d} | 0.2 | g^{g} | 0.2 | g^{o} | — | C | | |
| Ex-4B | 5 | g^{b} | 5 | g^{d} | 0.2 | g^{g} | 0.2 | g^{o} | — | C | | |
| Ex-4C | 8 | g^{b} | 2 | g^{d} | 0.2 | g^{g} | 0.2 | g^{o} | — | C | | |
| Ex-5 | 5 | g^{b} | 5 | g^{e} | — | | — | | — | B | | |
| Ex-6 | 5 | g^{b} | 5 | g^{e} | 0.2 | g^{g} | 0.2 | g^{o} | — | C | | |
| Ex-7B | 5 | g^{a} | 5 | g^{d} | — | | — | | — | B | | |
| Ex-7A | 5 | g^{a} | 5 | g^{d} | — | | 0.26 | g^{m} | — | B | | |
| Ex-8 | 2 | g^{c} | 8 | g^{d} | — | | — | | — | B | | |
| Ex-9 | 2 | g^{c} | 8 | g^{d} | 0.2 | g^{g} | 0.2 | g^{o} | — | C | | |

| | | | | | | | | | | |
|---|---|---|---|---|---|---|---|---|---|---|
| Ex-10A1 | 60 | g^{b} | — | 1 | g^{g} | 1 | g^{o} | 120 | mg^{h} | D |
| Ex-10A2 | 60 | g^{b} | — | 0.4 | g^{g} | 1 | g^{o} | 120 | mg^{h} | D |
| Ex-10A3 | 60 | g^{b} | — | 1.6 | g^{g} | 1 | g^{o} | 120 | mg^{h} | D |
| Ex-10B1 | 60 | g^{b} | — | 1 | g^{g} | 1 | g^{o} | 120 | mgⁱ | D |
| Ex-10B2 | 60 | g^{b} | — | 0.4 | g^{g} | 1 | g^{o} | 120 | mgⁱ | D |
| Ex-10B3 | 60 | g^{b} | — | 1.6 | g^{g} | 1 | g^{o} | 120 | mgⁱ | D |
| Ex-10C1 | 60 | g^{b} | — | 1 | g^{g} | 1 | g^{o} | 120 | mg^{k} | D |
| Ex-10C2 | 60 | g^{b} | — | 0.4 | g^{g} | 1 | g^{o} | 120 | mg^{k} | D |
| Ex-10C3 | 60 | g^{b} | — | 1.6 | g^{g} | 1 | g^{o} | 120 | mg^{k} | D |

| Ex-11A | 60 | g^{b} | — | | — | 1 | g^{o} | 120 | mg^{h} | D |
|---|---|---|---|---|---|---|---|---|---|---|
| Ex-11B | 60 | g^{b} | — | | — | 1 | g^{o} | 120 | mgⁱ | D |
| Ex-11C | 60 | g^{b} | — | | — | 1 | g^{o} | 120 | mg^{k} | D |
| Ex-12 | 30 | g^{b} | 30 | g^{d} | — | 1 | g^{o} | 120 | mg^{h} | D |
| Ex-13 | 30 | g^{a} | 30 | g^{d} | — | 1 | g^{m} | 120 | mg^{h} | D |

| | | | | | | | | | | | |
|---|---|---|---|---|---|---|---|---|---|---|---|
| Ex-14 | 60 | g^{b} | — | — | 1 | g^{o} | 30 | mg^{h} | C | 0.6 g^{p} | 2.0 g^{r} |
| Ex-15 | 60 | g^{b} | — | — | 0.2 | g^{o} | 36 | mg^{h} | D | | |

^{a}polyurethane dispersion U205; ^{b}aliphatic polycarbonate polyurethane dispersion U6800; ^{c}polyester polyurethane dispersion WS-5000; ^{d}polyacrylic dispersion AP609LN; ^{e}polyacrylic dispersion AP4609N; ^{f}fumed silica Aerosil R202; ^{g}fumed silica R972; ^{h}SkySpring Nanomaterials, Inc. Houston, none-coated Ag nanoparticles (99.95%, 20-30 nm, SkySpring Nanomaterials, Inc, Houston, TX, USA); ⁱPVP coated silver nanoparticles (99.95%, 20-30 nm, SkySpring Nanomaterials, Inc, Houston, TX, USA); ^{k}Oleic Acid coated silver nanoparticles (99.95%, 320-50 nm, SkySpring Nanomaterials, Inc, Houston, TX, USA); ^{m}DBE-311; ^{o}Tween 80; ^{p}thickener T-1000; ^{r}crosslinker XP2547; A) magnetic stir bar 12 hours stirring, no defoaming; B) Planetary centrifugal mixer (Thinky ARE-310) for 3 minutes and defoamed using the same for 2 min; C) magnetic stir bar for 15 hours and then defoamed (thinky ARE-310) 2 min; D) mixed on a rolling mixer for 24 hours.

### Example-16: Preparation of the Antifouling Coating

The solution from example 1 was casted on a stainless-steel substrate using a blade caster, using a wet thickness 625 μm; after being dried in air at room temperature, a dry coating of 300 μm thickness was obtained. The coating can also be brush coated or roller coated.

### Example-17: The Contact Angle Measurement and Water Droplet Area Measurement of the Antifouling Coating

For the water contact angle measurement, the substrate was placed on the stage of a contact angle meter Attension Theta lite TL 100 (Finland). 20 μl of DI water is placed on the horizontal surface of tested substrate by pipette, then the contact angle was measured and analyzed by the contact angle meter. The water contact angles of various coatings are shown in Table 2. All the coatings presented in the present disclosure showed water contact angle less than 5°, indicating they are superhydrophilic.

For the water droplet area measurement, 200 μl of DI water is placed on the horizontal surface of tested substrate by pipette. Comparing to the bare, uncoated stainless steel, the size of water droplets on the coating is 5-11 times bigger.

This unique feature of the present disclosed materials can make it a very attractive and practical solution for antifouling application.

TABLE 2
Contact angle and size of a water droplet on
the coatings compared to bare stainless steel

| | | Water | |
|---|---|---|---|
| | | contact | Area |
| Surface | Composition | angle (°) | (cm²) |
| Stainless steel | none | 60-70 | 1.1 |
| Polyether | U205 + R202 (5%) + polysorbate | <5 | 5.7 |
| PU/SSL | 80 (5%) | | |
| | U205 + R202 (3%) + DBE-311 | <5 | 5.9 |
| | (10%) [Ex-1] | | |
| | U205 + R202 (3%) + DBE-311 | <5 | 8.4 |
| | (10%) + polysorbate 80 (5%) | | |
| Polycarbonate | U6800 + polysorbate 80 (5%) | <5 | 6.3 |
| PU/SSL | U6800 + R202 (3%) + polysorbate | <5 | 11.8 |
| | 80 (5%) [Ex-2] | | |
| | U6800 + R202 (5%) + polysorbate | <5 | 9.3 |
| | 80 (5%) | | |

### Example-18: Biofilm Growth Test in CDC Biofilm Reactor

Coupons of U6800+R202 (5%)+ polysorbate 80 (5%) film on stainless steel, PTFE, untreated stainless steel with size of 2 cm×12 cm will be fixed into the sample holder of a CBR 90-3 CDC Biofilm Reactor® produced by Center for Biofilm Engineering at Montana State University). The growth of biofilm on those surfaces will be evaluated using Standard Test Method for Quantification of Pseudomonas aeruginosa Biofilm Grown with High Shear and Continuous Flow using CDC Biofilm Reactor (ASTM standard E2562-17). It is anticipated that the data will show that U6800+R202 (5%)+polysorbate 80 (5%) was the most effective inhibiting the growth of Pseudomonas aeruginosa Biofilm on its surface among all the samples.

TABLE 3
Biofilm growth test

| | Anti-biofilm (biofilm formation relative to that on |
|---|---|
| Material | stainless steel, in P. aeruginosa) |
| Stainless steel | 100% |
| PTFE | 62% |
| Cu plate | 72% |
| Ag plate | 20% |
| U6800 | |
| U6800 + R202 (5%) + | |
| polysorbate 80 (5%) | |

### Example 19. Coating Color Change Analysis

### Procedure of Coating Soaking in Water at Room Temperature:

The coating was placed in a container of water at room temperature. Its appearance in color was observed and recorded as time elapsed.

### Procedure of Coating Soaking in Water at 80° C.:

The coating was immersed in a container of water kept at 80° C. for 5 min. After that, the coating was lifted out of the container, dipped in another container of water at room temperature for 15 sec, and was briefly dried in air. Coating's appearance in color was observed and recorded. The above steps were repeated 25 times.

### Procedure of Coating Soaking in Aqueous Solution Having 30 ppm Sodium Hypochlorite:

The coating was immersed in a container of aqueous solution having 30 ppm sodium hypochlorite for 5 min. After that, the coating was lifted out of the container, dipped in another container of water at room temperature for 15 sec, and was briefly dried in air. The coating's appearance in color was observed and recorded. The above steps were repeated 25 times.

TABLE 4
Color change results

| | | Soaking in | Soaking in |
|---|---|---|---|
| | | water at room | 80° C. |
| Ex-# | | temperature | water |
| Ex-2 | U6800 + polysorbate 80 + | (17 h) white | (5 min) white |
| | R972 | | |
| Ex-10A | U6800 + polysorbate 80 + | (19 h) a little | (5 min) white |
| | R972 + AgNP | yellow | |
| Ex-15 | U6800 + polysorbate 80 + | (24 h) no color | (5 min) white |
| | AgNP | change | |
| Ex-14 | U6800 + polysorbate 80 + | (24 h) no color | (100 min) |
| | T1000 + AgNP + XP2547 | change | slightly yellow |

In Ex-2, coating turned white after 17 h soaking in water at room temperature, or 5 min soaking in water at 80° C. Adding AgNP to that recipe as in Ex-10A, soaking at room temperature was improved (after 19 h coating only turned a little yellow). In Ex-15, where R972 was absent, coating had no color change after 24 h soaking at room temperature. When thickener T1000 and crosslinker XP2547 were added to the mixture of U6800, polysorbate 80 and AgNP, as in Ex-14, coating only turned slightly yellow after 100 min soaking in water at 80° C.

Unless otherwise indicated, all numbers expressing quantities of ingredients, properties such as molecular weight, reaction conditions, and so forth used in the specification and embodiments are to be understood as being modified in all instances by the term “about.” Accordingly, unless indicated to the contrary, the numerical parameters set forth in the specification and attached embodiments are approximations that may vary depending upon the desired properties sought to be obtained. At the very least, and not as an attempt to limit the application of the doctrine of equivalents to the scope of the embodiments, each numerical parameter should at least be construed in light of the number of reported significant digits and by applying ordinary rounding techniques.

The terms “a,” “an,” “the” and similar referents used in the context of describing the present disclosure (especially in the context of the following embodiments) are to be construed to cover both the singular and the plural, unless otherwise indicated herein or clearly contradicted by context. All methods described herein can be performed in any suitable order unless otherwise indicated herein or otherwise clearly contradicted by context. The use of all examples, or exemplary language (e.g., “such as”) provided herein is intended merely to better illuminate the present disclosure and does not pose a limitation on the scope of any claim. No language in the specification should be construed as indicating any non-claimed element essential to the practice of the present disclosure.

Groupings of alternative elements or embodiments disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended embodiments.

Certain embodiments are described herein, including the best mode known to the inventors for carrying out the present disclosure. Of course, variations on these described embodiments will become apparent to those of ordinary skill in the art upon reading the foregoing description. The inventor expects skilled artisans to employ such variations as appropriate, and the inventors intend for the present disclosure to be practiced otherwise than specifically described herein. Accordingly, the embodiments include all modifications and equivalents of the subject matter recited in the embodiments as permitted by applicable law. Moreover, any combination of the above-described elements in all possible variations thereof is contemplated unless otherwise indicated herein or otherwise clearly contradicted by context.

In closing, it is to be understood that the embodiments disclosed herein are illustrative of the principles of the present disclosure. Other modifications that may be employed are within the scope of the embodiments. Thus, by way of example, but not of limitation, alternative embodiments may be utilized in accordance with the teachings herein. Accordingly, the embodiments are not limited to embodiments precisely as shown and described.

What is claimed is:

1. A superhydrophilic polymer composite comprising:
i. a waterborne polymer;
ii. a plurality of hydrophobic surface modified particles; and
iii. an amphiphilic compound;
wherein the superhydrophilic polymer composite is a uniform mixture.

2. The superhydrophilic polymer composite of claim 1, wherein the waterborne polymer comprises an aqueous polyurethane dispersion.

3. The superhydrophilic polymer composite of claim 2, wherein the aqueous polyurethane dispersion is a polyether polyurethane dispersion.

4. The superhydrophilic polymer composite of claim 2, wherein the aqueous polyurethane dispersion is an aliphatic polycarbonate polyurethane dispersion.

5. The superhydrophilic polymer composite of claim 1, wherein the hydrophobic surface modified particles comprise a modified fumed silica.

6. The superhydrophilic polymer composite of claim 5, wherein the modified fumed silica is modified with polydimethylsiloxane.

7. (canceled)

8. The superhydrophilic polymer composite of claim 1, wherein the amphiphilic compound comprises a polydimethylsiloxane polymer modified with hydrophilic side chains.

9. The superhydrophilic polymer composite of claim 8, wherein the polydimethylsiloxane polymer is modified with polyether side chains.

10. The superhydrophilic polymer composite of claim 1, wherein the amphiphilic compound comprises polysorbate 80.

11. The superhydrophilic polymer composite of claim 1, further comprising an acrylic polymer.

12. The superhydrophilic polymer composite of claim 1, further comprising an antimicrobial agent.

13. The superhydrophilic polymer composite of claim 12, wherein the antimicrobial agent comprises silver nanoparticles.

14. The superhydrophilic polymer composite of claim 1, further comprising a thickener.

15. The superhydrophilic polymer composite of claim 1, further comprising a crosslinker.

16. A surface coating, comprising the superhydrophilic polymer composite of claim 1.

17. The surface coating of claim 16, wherein the surface to be coated is a food processing surface, a malt or wort processing surface, a surface prone to biofilm formation, or a medical device surface.

18. The surface coating of claim 16, wherein the surface comprises stainless steel.

19. The surface coating of claim 18, having a water contact angle less than 5 degrees.

20. The surface coating of claim 19, having a water droplet area measurement at least 5 times greater than uncoated stainless steel.
